(19) United States
(12) Patent Application Publication
(10) Pub. No.: US 2025/0184999 A1
(43) Pub. Date: Jun. 5, 2025

(54) TECHNOLOGIES FOR AGGREGATION OF UPLINK TRANSMISSIONS

(71) Applicant: Apple Inc., Cupertino, CA (US)

(72) Inventors: Chunxuan Ye, San Diego, CA (US); Alexander Sayenko, Munich (DE); Anatoliy S. Ioffe, Sunnyvale, CA (US); Daniel Popp, Munich (DE); Dawei Zhang, Saratoga, CA (US); Fucheng Wang, Cupertino, CA (US); Wei Zeng, Saratoga, CA (US)

(73) Assignee: Apple Inc., Cupertino, CA (US)

(21) Appl. No.: 18/821,973

(22) Filed: Aug. 30, 2024

Related U.S. Application Data
(60) Provisional application No. 63/604,851, filed on Nov. 30, 2023.

(51) Int. Cl. H04W 72/1268; H04W 72/02; H04W 72/543; H04W 72/563

(52) U.S. Cl. CPC H04W 72/1268; H04W 72/02; H04W 72/543; H04W 72/563

(57) ABSTRACT

The present application relates to devices and components including apparatuses, systems, and methods for supporting aggregation of uplink communications.

### CROSS-REFERENCE TO RELATED APPLICATION

This application claims the benefit of U.S. Provisional Patent Application No. 63/604,851, filed on Nov. 30, 2023, which is herein incorporated by reference in its entirety for all purposes.

### BACKGROUND

Third Generation Partnership Project (3GPP) Technical Specifications (TSs) define standards for wireless networks. These TSs describe aspects related to user plane and control plane signaling over the networks.

### BRIEF DESCRIPTION OF THE DRAWINGS

FIG. 1 illustrates a network environment in accordance with some embodiments.

FIG. 2 illustrates a signaling diagram in accordance with some embodiments.

FIG. 3 illustrates uplink grants in accordance with some embodiments.

FIG. 4 illustrates uplink grants in accordance with some embodiments.

FIG. 5 illustrates another signaling diagram in accordance with some embodiments.

FIG. 6 illustrates another signaling diagram in accordance with some embodiments.

FIG. 7 illustrates another signaling diagram in accordance with some embodiments.

FIG. 8 illustrates another signaling diagram in accordance with some embodiments.

FIG. 9 illustrates another signaling diagram in accordance with some embodiments.

FIG. 10 illustrates configurations in accordance with some embodiments.

FIG. 11 illustrates an operation flow/algorithmic structure in accordance with some embodiments.

FIG. 12 illustrates another operation flow/algorithmic structure in accordance with some embodiments.

FIG. 13 illustrates another operation flow/algorithmic structure in accordance with some embodiments.

FIG. 14 illustrates a user equipment in accordance with some embodiments.

FIG. 15 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

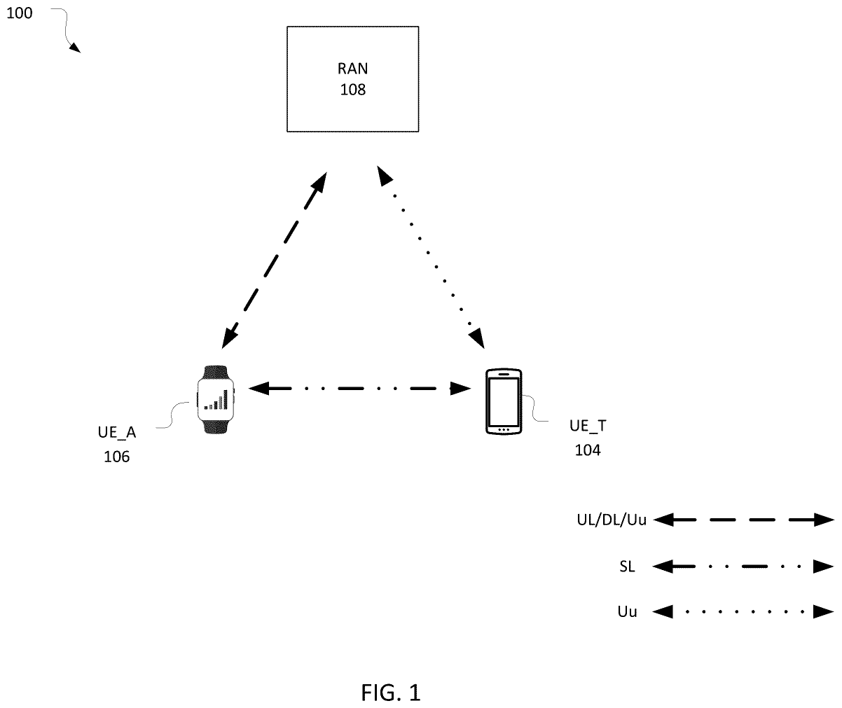

FIG. 1 illustrates a network environment 100 in accordance with some embodiments. The network environment 100 may include user equipments (UEs) 104 and 106 and a radio access network (RAN) 108. The RAN 108 may include various network nodes such as base stations, transmit-receive points (TRPs), etc., to facilitate provision of one or more serving cells that provide user plane and control plane protocol terminations toward the UEs 104/106. In some embodiments, the RAN 108 may include a gNB to provide one or more New Radio (NR) serving cells.

In some embodiments, the RAN 108 may include one or more non-terrestrial network (NTN) devices to facilitate provision of an access link of the serving cells. An NTN device may be an earth-fixed satellite (such as a geosynchronous (GEO) earth orbit satellite or a high altitude platform station (HAPS)), a quasi-earth-fixed satellite (such as a non-geostationary Earth orbit (NGEO) satellite with steerable beam), or an Earth-moving satellite (such as an NGEO with fixed or non-steerable beam). The NTN device may facilitate a wireless connection between a base station and the UEs 104/106 by relaying signals between the two network devices. The signals may be relayed over a first service link between the NTN device and base station and a second service link between the NTN device and the UEs 104/106. When incorporating one or more NTN devices, the RAN 108 may be referred to as an NTN.

A number of enhancements may be considered to increase coverage in NTNs. In some embodiments, uplink capacity and throughput enhancement in NTNs may be obtained by enabling the UEs 104/106 to operate as an aggregated UE that cooperates to improve uplink or downlink communications. An aggregated UE may include a target UE and one or more assistant (or auxiliary) UEs. The uplink/downlink communications performed by the assistant UEs may be for the benefit of the target UE that is the source or destination of the communicated information. For embodiments described herein, the UE 104 may be considered the target UE (UE_T) and the UE 106 may be considered the assistant UE (UE_A). However, these roles may be dynamic and may change over time. The target UE 104 and the assistant UE 106 may belong to the same user or may belong to different users. The target UE 104 is shown generally as a mobile phone, while the assistant UE 106 is shown generally as a smart watch. These depictions are not restrictive. In other embodiments, other types of UEs may be used as target/assistant UEs.

When cooperating to operate as an aggregated UE, the UEs 104/106 may essentially function like a virtual, high-power UE (HPUE) that includes more platform resources than the UEs 104/106 do individually. In this manner, the UE aggregation may provide more transmit power, antenna/RF chains, antenna diversity, etc. Further, given typical constraints of existing HPUEs (for example, a PC2 UE has 50% duty cycle and PC1.5 UE has a 25% duty cycle), an aggregated UE may provide additional efficiencies by taking advantage of a diversified transmission platform.

The UEs 104/106 and the RAN 108 may communicate over air interfaces compatible with 3GPP TSs such as those that define Fifth Generation (5G) NR system standards. In some embodiments, the target UE 104 and the assistant UE 106 may communicate with the RAN 108 over Uu interface and may communicate with one another over a sidelink (SL) interface. The sidelink interface may be any type of wired or wireless interface. For example, the sidelink interface may be an interface of a wireless personal area network technology, a wireless local area network technology, or a wireless wide area network technology.

Embodiments describe various aspects of uplink UE aggregation that may be used to improve communication efficiencies in both terrestrial and non-terrestrial networks. Some of these aspects are briefly introduced as follows.

In some aspects, the involvement of the assistant UE 106 in uplink UE aggregation may be non-transparent to the RAN 108. That is, the RAN 108 may have knowledge of the participation of the assistant UE 106 in the uplink UE aggregation. This aspect may be referred to hereinafter as Case A.

In some aspects, the involvement of the assistant UE 106 in uplink UE aggregation may be transparent to the RAN 108. That is, the RAN 108 may not have knowledge of the participation of the assistant UE 106 in the uplink UE aggregation. This aspect may be referred to hereinafter as Case B.

In some aspects, the target UE 104 and the assistant UE 106 may operate in a joint uplink transmission mode in which each UE performs an uplink transmission jointly with the other UE. This aspect may be referred to hereinafter as Case X.

In some aspects, the target UE 104 and the assistant UE 106 may operate in an alternative uplink transmission mode in which each UE performs alternate uplink transmissions. The uplink transmissions may alternate in a frequency domain or time domain as will be discussed. This aspect may be referred to hereinafter as Case Y.

The target UE 104 and the assistant UE 106 may operate in various uplink grant reception modes. In a first aspect, referred to as Case 1, only the target UE 104 may receive the uplink grant from the RAN 108. The target UE 104 may then forward the uplink grant (or a portion thereof) to the assistant UE 106. In a second aspect, referred to as Case 2, the target UE 104 and the assistant UE 106 may jointly receive the uplink grant from the RAN 108. In a third aspect, referred to as Case 3, the target UE 104 and the assistant UE 106 may separately receive uplink grants from the RAN 108.

The target UE 104 and the assistant UE 106 may operate in various reception modes for receiving uplink transmission control parameters including, for example, power control parameters and timing advance (TA) control parameters. In a first aspect, referred to as Case a, only the target UE 104 may receive the uplink transmission control parameters from the RAN 108. The target UE 104 may then forward the uplink transmission control parameters (or portions thereof) to the assistant UE 106. In a second aspect, referred to as Case b, the target UE 104 and the assistant UE 106 may jointly receive the uplink transmission control parameters from the RAN 108. In a third aspect, referred to as Case c, the target UE 104 and the assistant UE 106 may separately receive uplink transmission control parameters from the RAN 108.

Other aspects that will be described herein include trigger conditions of uplink UE aggregation, UL UE aggregation report, modified UL grant, and sidelink resource allocations.

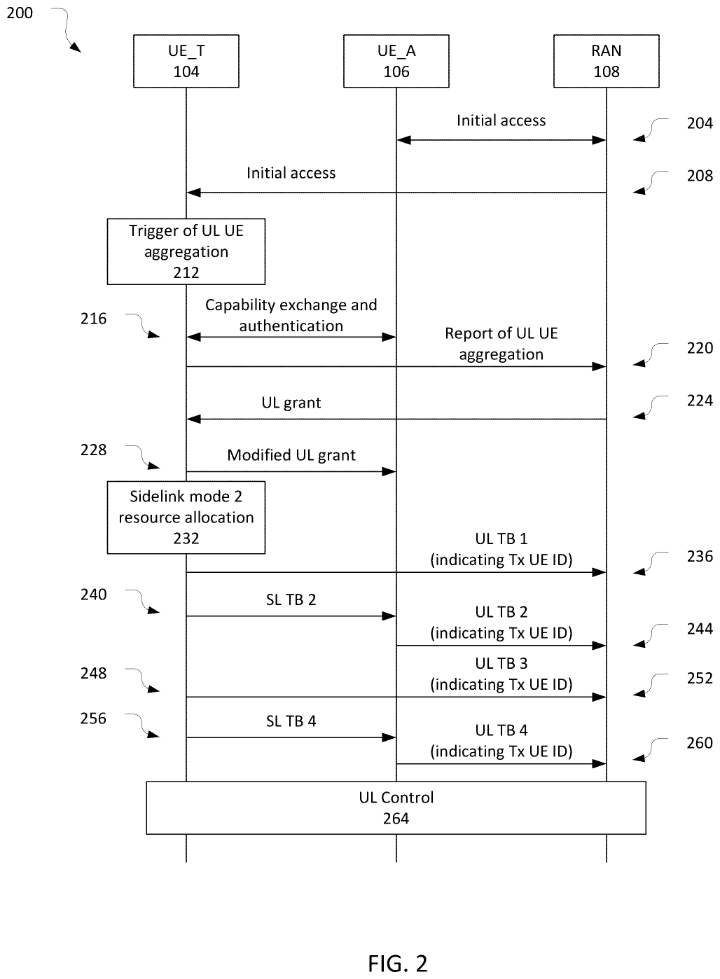

FIG. 2 is a signaling diagram 200 illustrating aspects of uplink UE aggregation in accordance with some embodiments. The signaling diagram 200 may include operations performed by, and signaling messages transmitted between, the target UE 104, the assistant UE 106, and the RAN 108. Operations described with respect to the RAN 108 may be performed by one or components of the RAN including, for example, a base station, a TRP, an NTN device, etc. The signaling diagram 200 represents an embodiment in which uplink UE aggregation is performed in accordance with Case A, Y, 1, c aspects.

At 204, the signaling diagram 200 may include the assistant UE 106 gaining initial access to the RAN 108. This may include a number of operations including, for example, random-access channel procedures to acquire uplink synchronization and obtain specified identifiers for radio access communication; registration; configuration; etc.

At 208, the signaling diagram 200 may include the target UE 104 gaining initial access to the RAN 108. This may be similar to that described above with respect to 204.

At 212, the signaling diagram 200 may include the target UE 104 detecting a trigger of an uplink (UL) UE aggregation. In some embodiments, the triggering conditions of the UL UE aggregation may include the target UE 104 detecting that its uplink transmission rate is below a predetermined threshold. The predetermined threshold may be configured by, for example, a 3GPP TS, or dynamically provided by the RAN 108. In some embodiments, the triggering conditions of the UL UE may include the target UE 104 detecting that its UL transmission rate is lower than an UL data arrival rate. The UL data arrival rate may be the rate at which a lower layer (for example, a communication protocol layer) of the target UE 104 receives data, which is to be transmitted in an uplink, from an upper layer (for example, an application layer) of the target UE 104.

At 216, the signaling diagram 200 may include the target UE 104 and the assistant UE 106 engaging in a capability exchange and authentication operation. In some embodiments, the assistant UE 106 may inform the target UE 104 of an UL UE aggregation capability of the assistant UE 106. The UL UE aggregation capability may indicate that the assistant UE 106 has a capability of NTN communication or has a connection with the same access node as the target UE 104.

The UL UE aggregation capability may additionally/alternatively provide an indication of a transmission load of the assistant UE 106. The transmission load may relate to data originating from, or destined to, the assistant UE 106. If the assistant UE 106 does not have a heavy uplink transmission load, for example, its uplink transmission load is below a predetermined threshold, the assistant UE 106 may be available for transmitting some of the data from the target UE 104 in an UL UE aggregation.

The UL UE aggregation capability may additionally/alternatively provide an indication of a location or proximity of the assistant UE 106. For example, the UL UE aggregation capability may indicate that the assistant UE 106 is located within a certain distance of the target UE 104. Location within the certain distance, may indicate the assistant UE 106 is able to participate in an UL UE aggregation with the target UE 104.

At 220, the signaling diagram 200 may include the target UE 104 transmitting, to the RAN 108, a report of the UL UE aggregation. In some embodiments, the report may indicate that the assistant UE 106 is participating in the UL UE aggregation. The report may include an identity associated with the assistant UE 106.

At 224, the signaling diagram 200 may include the RAN 108 providing a UL grant to the target UE 104. The UL grant may be a dynamic or configured grant that indicates uplink resources that may be used for transmitting the data from the target UE 104.

At 228, the signaling diagram 200 may include the target UE 104 providing a modified UL grant to the assistant UE 106. The modified UL grant may provide at least a portion of the uplink resources from the uplink grant received at 224 to the assistant UE 106. This may allow the assistant UE 106 to transmit data of the UL UE aggregation to the RAN 108.

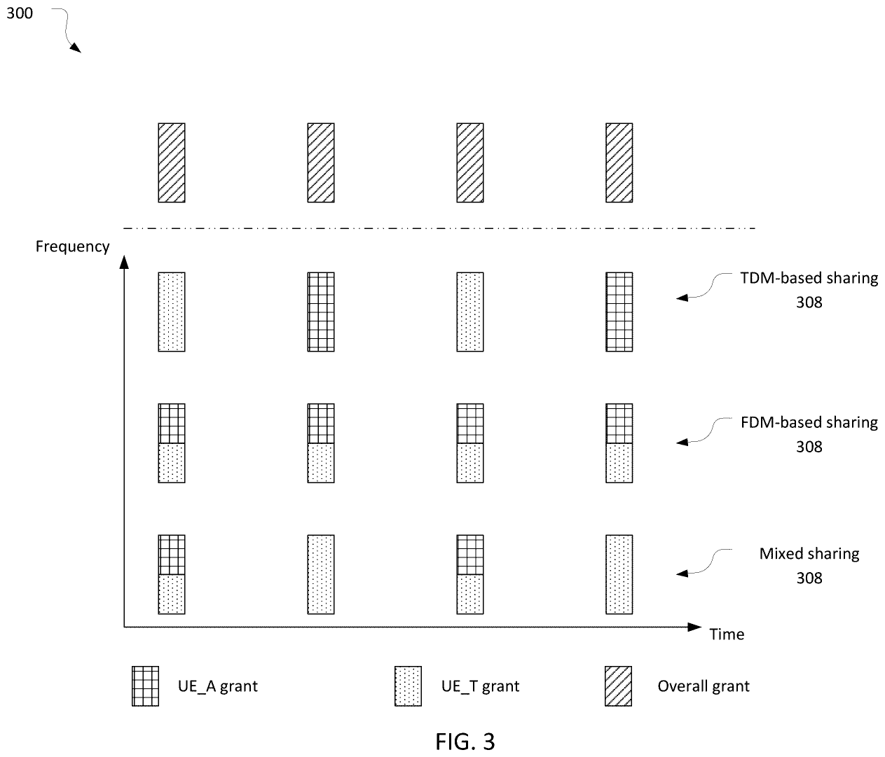

FIG. 3 illustrates uplink grants 300 in accordance with some embodiments. In particular, the uplink grants 300 include the overall grant that is provided in, for example, the uplink grant transmitted at 224. As shown, the overall grant includes resources at four time occasions. The overall grants may be divided between the target UE 104 and the assistant UE 106 according to a time-division multiplexing (TDM)-based sharing scheme 304, a frequency-division multiplexing (FDM)-based sharing scheme 308, or a mixed sharing scheme 312.

In the TDM-based sharing scheme 304, the target UE 104 may allocate part of the uplink grant in the time domain for UE aggregation. The modified UL grant may include a periodicity that is modified from the overall uplink grant. In this manner, the target UE 104 may utilize UL grants at some of the time occasions for itself and may provide UL grants at other time occasions to the assistant UE 106 via the modified UL grant. For example, as shown, the target UE 104 may use the UL grants at the first and third time occasions, while providing the second and fourth UL grants to the assistant UE 106 through the modified UL grant.

In the FDM-based sharing scheme 308, the target UE 104 may allocate part of the grant in the frequency domain for UE aggregation. The modified UL grant may include a frequency resource allocation that is modified from the overall uplink grant. In this manner, the target UE 104 may utilize a first frequency portion of each UL grant for itself and provide a second frequency portion of each UL grant to the assistant UE 106 via the modified UL grant.

In the mixed sharing scheme 312, the target UE 104 may allocate part of the grant in time and frequency domains for UE aggregation. For example, as shown, the target UE 104 may utilize first frequency portions of the UL grant at the first and third occasions for itself and may further utilize the entirety of the UL grants at the second and fourth occasions. The target UE 104 may provide second frequency portions of the UL grant at the first and third occasions to the assistant UE 106 via the modified UL grant.

Variations of these sharing schemes may be used without departing from the teaching of this disclosure.

In some embodiments, the generation of the modified UL grant and provision of the modified UL grant to the assistant UE 106 at 228 may be based on the type of uplink grant received at 224.

In some embodiments, the uplink grant received at 224 may be for a configured grant (CG) physical uplink shared channel (PUSCH). The CG PUSCH may be a Type-1 CG allocation that is fully configured and released using RRC signaling. Alternatively, the CG PUSCH may be a Type-2 CG allocation in which the resource allocation is partially configured using RRC signaling but is subsequently activated or deactivated using physical downlink control channel (PDCCH) transmissions.

The target UE 104 may send the UE_T's CG configuration to the assistant UE 106 via the modified UL grant. The UE_T's radio network temporary identifier (RNTI) (for example, a cell-RNTI (C-RNTI or an RNTI designed specifically for UL UE aggregation)) may also be sent to the assistant UE 106. This RNTI may be sent in the modified UL grant or as part of the capability exchange and authentication at 216. The UE_T's RNTI may be used for PUSCH scrambling operations by the assistant UE 106.

In some embodiments, the uplink grant received at 224 may be for a dynamic grant (DG) PUSCH. In some embodiments, the target UE 104 may provide the assistant UE 106 with the UE_T's PUSCH configuration (PUSCH-config). The assistant UE 106 may usc the data scrambling identity PUSCH (dataScramblingIdentityPUSCH) from the PUSCH-config for the PUSCH transmitted by the assistant UE 106 as part of the UL UE aggregation. The PUSCH-config (or portions thereof) may be transmitted to the assistant UE 106 in the modified UL grant or as part of the capability exchange and authentication at 216.

The signaling diagram 200 may further include, at 232, a sidelink mode 2 resource allocation. In mode 2 resource allocation, the target UE 104 may sense a sidelink channel and select its own resources from the sidelink resource pool for transmission. Mode 2 resource allocation may include a plurality of operations including, for example: resource pool configuration; sensing; and resource (re) selection.

The resource allocation at 232 may be performed based on the assumption that the target UE 104 needs to pass the uplink data to the assistant UE 106 before the UE_A's grant. The target UE 104 may select a periodic sidelink resource to pass the uplink data to the assistant UE 106 for the data transmission in mode 2.

In some embodiments, the sidelink data periodicity may be configured based on whether the uplink grant provided at 224 is a CG uplink grant or a DG uplink grant. If the uplink grant is a CG uplink grant, the sidelink data periodicity may be set to be the same as the UE_A grant. If the uplink grant is a DG uplink grant, the sidelink data periodicity may be set to zero. For example, the sidelink data may be considered aperiodic.

The sidelink data priority may be aligned with the uplink data. For example, a mapping rule may be used to map and uplink data priority to a sidelink data priority. The mapping rule may be predefined in, for example, a 3GPP TS, or configured by the RAN 108. In some embodiments, the data priority mapping may be done at a physical layer or a logical layer. The physical layer data priority mapping may map certain types of the data to certain priority values. For example, ultra-reliable low latency communication (URLCC) data may be mapped to sidelink data priority value 1 while enhanced mobile broadband (cMBB) data may be mapped to sidelink data priority value 4. The logical layer data priority mapping may map certain logical channel priorities to sidelink data priorities. For example, uplink data logical channel priority level 1 may be mapped to sidelink data priority value 2.

In yet another example, the mapping rule for mapping uplink data priority to the sidelink data priority may be based on a 5G quality of service identifier (5QI)-to-PC5 5QI (PQI) mapping. The PQI is a special 5QI that is used as a reference to PC5 quality of service (QoS) characteristics (e.g., parameters that control QoS forwarding for packets over a PC5 reference point between UEs on a sidelink).

In some embodiments, the target UE 104 may select a number of subchannels for the sidelink transmissions based on a frequency allocation of the modified UL grant provided to the assistant UE 106 at 228.

As mentioned above, the target UE 104 may perform the sidelink mode 2 resource allocation by selecting sidelink resources from a resource selection window. In some embodiments, the location of the resource selection window may be tied to the UE_A grant.

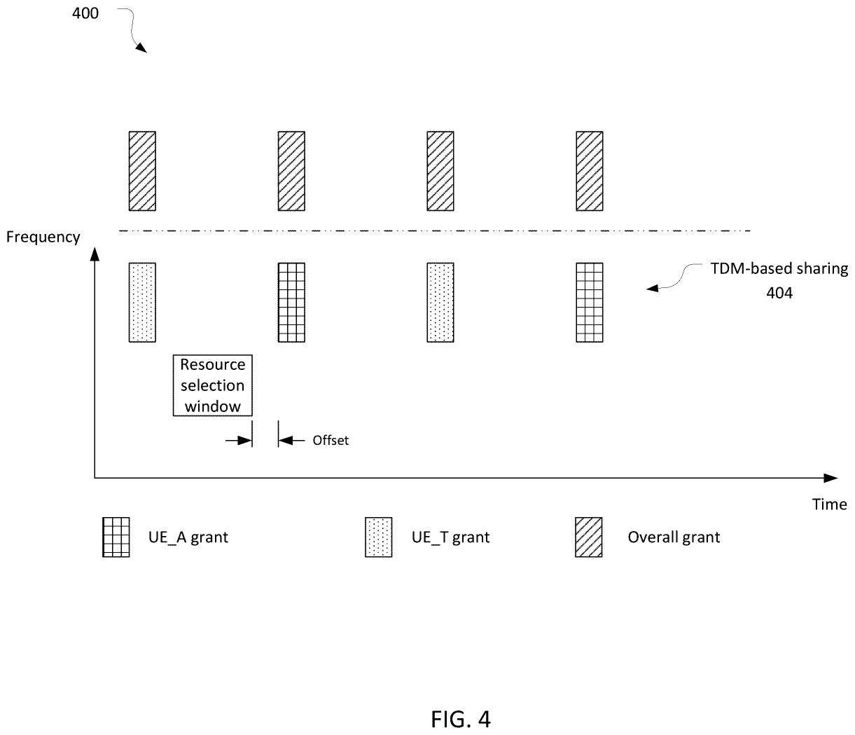

FIG. 4 illustrates uplink grants 400 in accordance with some embodiments. In particular, the uplink grants 400 include the overall grant that is provided in, for example, the uplink grant transmitted at 224. As shown, the overall grant includes resources at four time occasions. The overall grants may be divided between the target UE 104 and the assistant UE 106 according to a time-division multiplexing (TDM)-based sharing scheme 404.

The resource selection window may end an offset before the starting time of the UE_A grant. This may be accomplished by the target UE 104 setting a sidelink remaining packet delay budget (PDB) to the desired offset. The offset may allow for the assistant UE 106 sufficient time to decode the physical sidelink shared channel (PSSCH) to obtain the data from the target UE 104 and time to prepare the PUSCH transmission to be sent to the RAN 108.

After selecting the sidelink resources at 232, the target UE 104 may transmit some portions of data to the assistant UE 106 via the sidelink and transmit other portions of data directly to the RAN 108. For example, the target UE 104 may transmit UL transport blocks (TBs) 1 and 3 to the RAN 108 at 236 and 248, respectively, and transmit TBs 2 and 4 to the assistant UE 106 at 240 and 248, respectively. Upon receiving TBs 2 and 4 over the sidelink, the assistant UE 106 may forward them to the RAN 108 at 244 and 260, respectively.

The TB transmissions to the RAN 108 may include a UE identifier (ID) of the transmitting entity. For example, transmission 236 carrying UL TB 1 and transmission 252 carrying UL TB 3 may include UE ID of the target UE 104; while the transmission 244 carrying UL TB 2 and transmission 260 carrying UL TB 4 may include the UE ID of the assistant UE 106. The UE IDs may be carried in a MAC CE that is associated with the PUSCH transmission. The RAN 108 may use the UE IDs for separate power control and TA control for the target UE 104 and the assistant UE 106.

In some embodiments, the configuration of the PUSCH demodulation reference signal (DMRS) from the assistant UE 106 may be the same as the configuration of the PUSCH DMRS from the target UE 104. The DMRS configuration, which may include the identifier used for PUSCH DMRS sequence generation and the PUSCH DMRS type, may be part of an uplink configured grant sent from the target UE 104 to the assistant UE 106. The uplink configured grant may be sent to the assistant UE 106 as part of the capability exchange and authentication at 216 or in the modified UL grant at 228.

In some embodiments, the scrambling of the PUSCH coded bits may be different for CG PUSCHs and DG PUSCHs.

For CG PUSCH transmissions, a common RNTI may be used for the transmissions from both the target UE 104 and the assistant UE 106. In some embodiments, the RNTI may be a C-RNTI associated with the target UE 104 and may be used to scramble PUSCH coded bits before modulation. In other embodiments, the RNTI may be a new RNTI used for UE aggregation mode.

For DG PUSCH transmissions, the dataScramblingIdentityPUSCH value provided in the UE_T's PUSCH-config may be used for the transmissions from both the target UE 104 and the assistant UE 106.

The signaling diagram 200 may further include, at 264, the RAN 108 providing UL control information to the target UE 104 and the assistant UE 106. The RAN 108 may determine which UE has transmitted a particular uplink transmission and determine closed-loop TA control and power control values accordingly. These values may then be provided to the corresponding UE at 264.

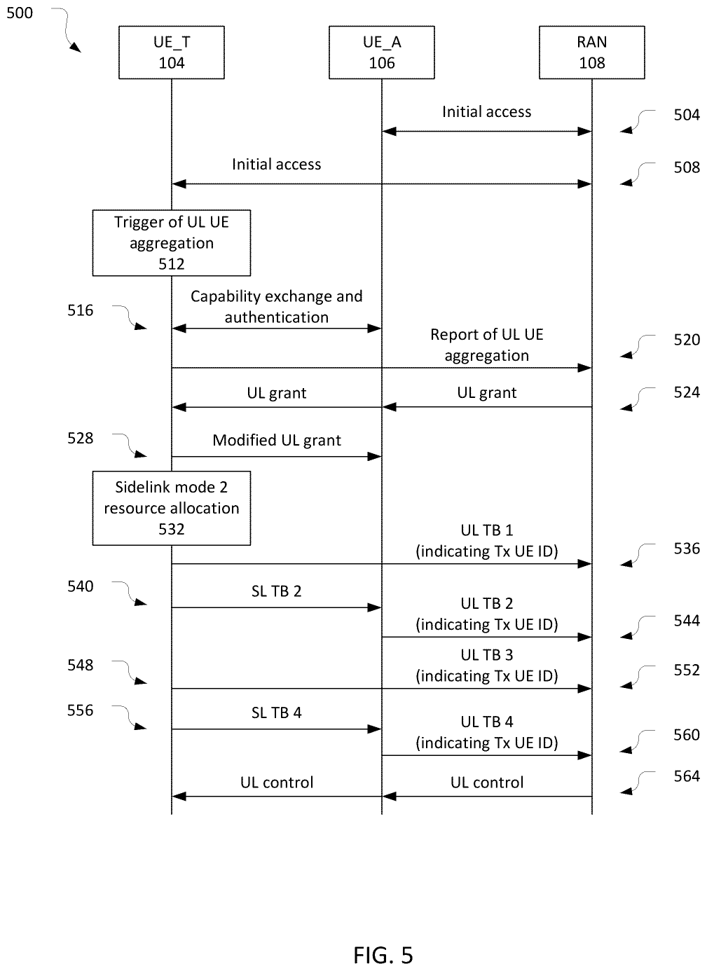

FIG. 5 is a signaling diagram 500 illustrating aspects of uplink UE aggregation in accordance with some embodiments. The signaling diagram 500 may include operations performed by, and signaling messages transmitted between, the target UE 104, the assistant UE 106, and the RAN 108. Operations described with respect to the RAN 108 may be performed by one or components of the RAN including, for example, a base station, a TRP, an NTN device, etc. The signaling diagram 500 represents an embodiment in which uplink UE aggregation is performed in accordance with Case A, Y, 2, c aspects. Except as otherwise described, operations of the signaling diagram 500 may be similar to like-named operations of the signaling diagram 200.

Signaling diagram 500 differs from signaling diagram 200 due to a variation in the uplink grant reception mode. In particular, signaling diagram 500 includes, at 524, a joint UL grant sent to both the assistant UE 106 and the target UE 104. That is, the same grant may be sent to both UEs. Providing the joint UL grant may save signaling overhead by providing a single grant from the network to both UEs.

In some embodiments, a group common DCI may be sent to both the assistant UE 106 and the target UE 104. The group common DCI may provide the dynamic uplink grant.

In other embodiments, the target UE 104 may share its C-RNTI or a new RNTI with the assistant UE 106. In this way, the assistant UE 106 can receive either a dynamic uplink grant or a configured uplink grant based on the provided RNTI. The RNTI may be provided to the assistant UE 106 in the capability exchange and authentication at 516.

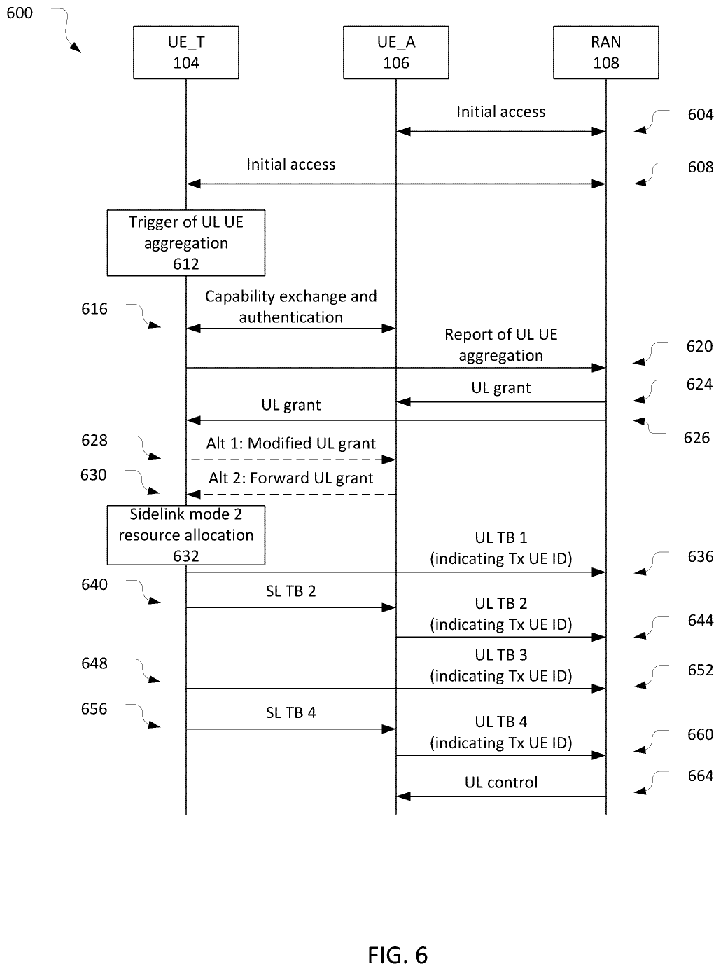

FIG. 6 is a signaling diagram 600 illustrating aspects of uplink UE aggregation in accordance with some embodiments. The signaling diagram 500 may include operations performed by, and signaling messages transmitted between, the target UE 104, the assistant UE 106, and the RAN 108. Operations described with respect to the RAN 108 may be performed by one or components of the RAN including, for example, a base station, a TRP, an NTN device, etc. The signaling diagram 600 represents an embodiment in which uplink UE aggregation is performed in accordance with Case A, Y, 3, c aspects. Except as otherwise described, operations of the signaling diagram 600 may be similar to like-named operations of the signaling diagram 200.

Signaling diagram 600 differs from signaling diagram 200 due to a variation in the uplink grant reception mode. In particular, signaling diagram 600 includes the RAN 108 transmitting an UL grant to the assistant UE 106 at 624 and transmitting an UL grant to the target UE 104 at 626.

In some embodiments, referred to as alternative 1, the same grant may be sent at 624 and 626. In these embodiments, the target UE 104 may send a modified UL grant to the assistant UE 106 at 628.

In some embodiments, referred to as alternative 2, independent grants may be sent at 624 and 626. For example, the UL grant sent to the assistant UE 106 may be an UL grant that is specific to the assistant UE 106, and the UL grant sent to the target UE 104 may be an UL grant that is specific to the target UE 104. In these embodiments, the assistant UE 106 may, at 630, transmit an indication of the UL grant for the assistant UE 106 to the target UE 104. This will allow the target UE 104 to use the UE_A UL grant for the sidelink resource allocation at 632.

In some embodiments, referred to as alternative 3, the UL grant sent to the target UE 104 at 626 may be a superset of the UL grant sent to the assistant UE 106 at 624. Thus, the target UE 104 may know both its own uplink grant and the UE_A uplink grant. The latter of which may be used for the sidelink resource allocation at 632.

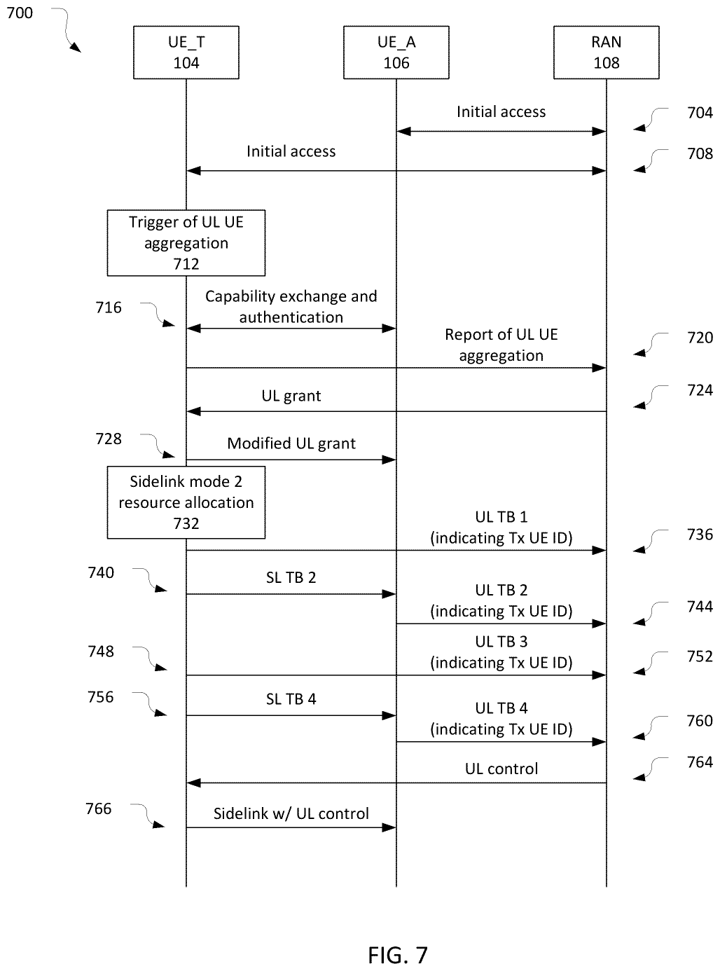

FIG. 7 is a signaling diagram 700 illustrating aspects of uplink UE aggregation in accordance with some embodiments. The signaling diagram 700 may include operations performed by, and signaling messages transmitted between, the target UE 104, the assistant UE 106, and the RAN 108. Operations described with respect to the RAN 108 may be performed by one or components of the RAN including, for example, a base station, a TRP, an NTN device, etc. The signaling diagram 700 represents an embodiment in which uplink UE aggregation is performed in accordance with Case A, Y, 1, a aspects. Except as otherwise described, operations of the signaling diagram 700 may be similar to like-named operations of the signaling diagram 200.

Signaling diagram 700 differs from signaling diagram 200 due to variations on uplink transmission control reception mode. In particular, signaling diagram 700 includes the RAN 108 transmitting, at 764, the uplink control to the target UE 104 only. The transmission may include a MAC CE with a UE ID to identify the UE with which the uplink control information is to be applied. For example, the RAN 108 may indicate in a TA command MAC CE whether this TA command is for the assistant UE 106 or the target UE 104. If the TA command MAC CE is for the assistant UE 106, the target UE 104 may forward the control information to the assistant UE 106 at 766. As the transmission at 766 is in the sidelink, a sidelink MAC CE may be used to carry this uplink TA command information.

For an uplink dynamic grant, the uplink grant DCI may have a “transmit power control (TPC) command” field. In some embodiments, additional fields in the uplink grant DCI may be added to indicate whether this TPC command is for the target UE 104 or for the assistant UE 106. The uplink grant DCI may be DCI format 0_1 or 0_2.

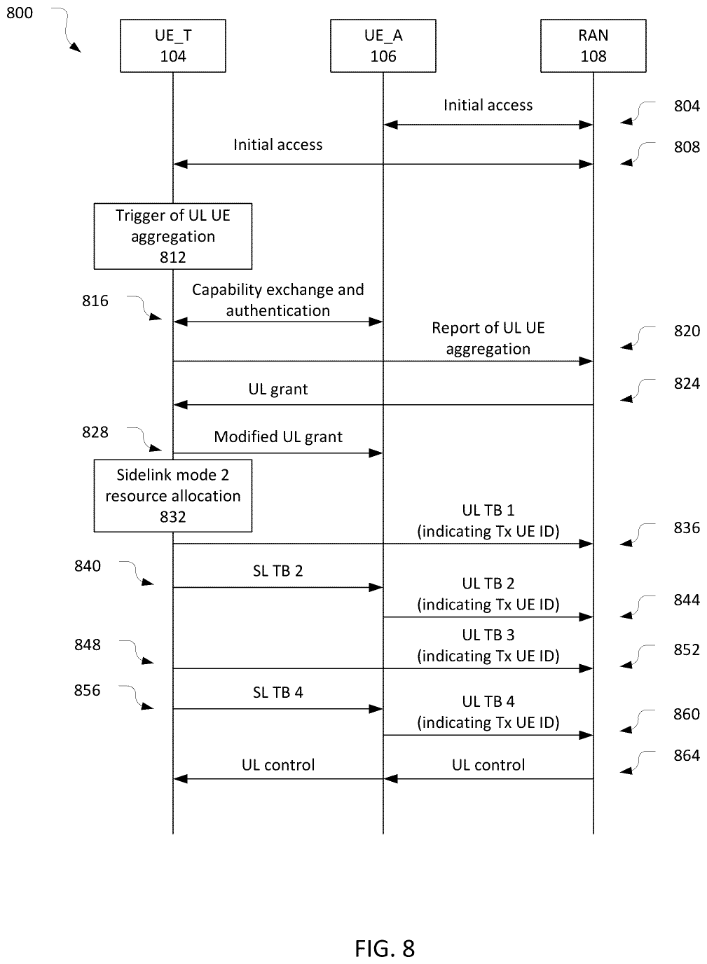

FIG. 8 is a signaling diagram 800 illustrating aspects of uplink UE aggregation in accordance with some embodiments. The signaling diagram 800 may include operations performed by, and signaling messages transmitted between, the target UE 104, the assistant UE 106, and the RAN 108. Operations described with respect to the RAN 108 may be performed by one or components of the RAN including, for example, a base station, a TRP, an NTN device, etc. The signaling diagram 800 represents an embodiment in which uplink UE aggregation is performed in accordance with Case A, Y, 1, b aspects. Except as otherwise described, operations of the signaling diagram 800 may be similar to like-named operations of the signaling diagram 200.

Signaling diagram 800 differs from signaling diagram 200 due to variations on uplink transmission control reception mode. In particular, signaling diagram 800 includes, at 864, the RAN 108 jointly transmitting uplink transmission control information to the target UE 104 and the assistant UE 106. For the TPC command, the transmissions at 864 may include a DCI format 2_2. For a TA command, the transmissions at 864 may include a new DCI format 2_X, which may be designed as a group common TA command.

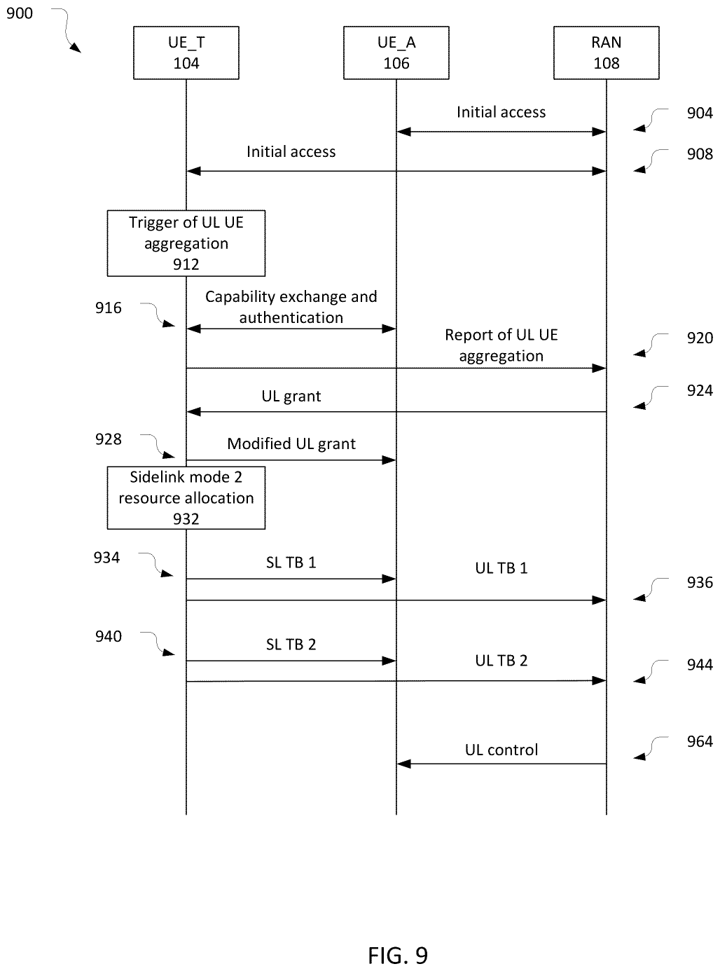

FIG. 9 is a signaling diagram 900 illustrating aspects of uplink UE aggregation in accordance with some embodiments. The signaling diagram 900 may include operations performed by, and signaling messages transmitted between, the target UE 104, the assistant UE 106, and the RAN 108. Operations described with respect to the RAN 108 may be performed by one or components of the RAN including, for example, a base station, a TRP, an NTN device, etc. The signaling diagram 900 represents an embodiment in which uplink UE aggregation is performed in accordance with Case A, X, 1, c aspects. Except as otherwise described, operations of the signaling diagram 900 may be similar to like-named operations of the signaling diagram 200.

Signaling diagram 900 differs from signaling diagram 200 due to variations on uplink transmissions. In particular, signaling diagram 900 includes joint uplink transmissions from the target UE 104 and the assistant UE 106.

To enable the joint uplink transmissions, the triggering of the UL UE aggregation at 912 may include a triggering condition in which a distance between the assistant UE 106 and the target UE 104 is less than a predetermined threshold. In some embodiments, this may be determined based on both UEs being configured with the same value of a UE-specific Koffset, which may be an offset used to determine various timing relationships. A UE-specific Koffset may be provided to the UEs after an initial access through control signaling such as, for example, RRC reconfiguration or a MAC CE. The proximity between the two UEs may be determined in other manners in other embodiments.

In some embodiments, the target UE 104 may send a precoding matrix indicator (PMI) configuration for the assistant UE 106 in the modified UL grant at 928. The PMI configuration may include precoding information that is to be used by both the target UE 104 and the assistant UE 106 in uplink transmissions to the RAN 108.

At 934, the target UE 104 may send TB 1 to the assistant UE 106 via the sidelink. This may be done in advance of a first joint uplink transmission occasion. At the first joint uplink transmission occasion, at 936, both the target UE 104 and the assistant UE 106 may send the TB1 to the RAN 108.

At 940, the target UE 104 may send TB 2 to the assistant UE 106 via the sidelink. This may be done in advance of a joint uplink transmission occasion. At the second joint uplink transmission occasion, at 944, both the target UE 104 and the assistant UE 106 may send the TB 2 to the RAN 108.

In some embodiments, the joint uplink transmission may only occur if a TB is successfully received at the assistant UE 106 via the sidelink.

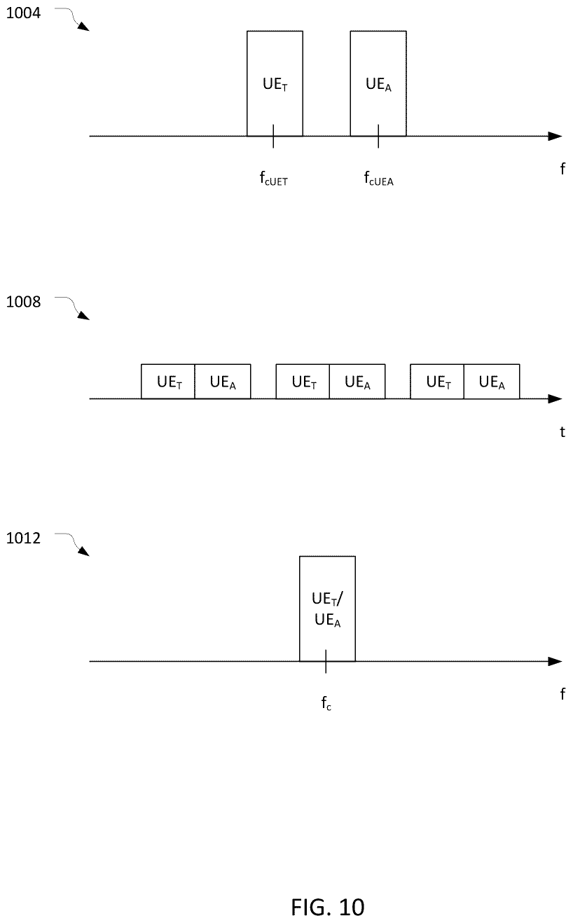

When the RAN 108 assigns a grant to the target UE 104 and the assistant UE 106, the same carrier frequency may be configured. The carrier frequency may be configured via a 5G absolute radio-frequency channel number (ARFCN) value (5GARFCN-ValueNR) information element (IE) that includes a frequency information uplink (FrequencyInfoUL) IE. The two UEs transmitting on the same carrier frequency may lead to signal nullification at a receiver antenna (for example, an NTN device) if, for example, a phase offset between the two signals is 180°. This may be addressed by configuring the uplink transmissions in accordance with one or more of the configurations 1004, 1008, and/or 1012 illustrated in FIG. 10 in accordance with some embodiments.

In configuration 1004, the RAN 108 may configure a different value for IE ARFCN-ValueNR for the assistant UE 106. Thus, the two UEs may use separate carrier frequencies, which may avoid certain drawbacks such as signal nullification. The RAN 108 can aggregate the information of the two streams (and consequently increase signal-to-noise ratio (SNR)) during a demodulation procedure.

Configuration 1008 may be used in embodiments in which one or more of the UEs are to employ a restricted duty cycle or scheduling restriction to comply with, for example, specific absorption rate (SAR) regulations. This may be the case if one of the UEs is a HPUE with PC2 or higher. Restricting the duty cycle may leave gaps in the UL transmission. Thus, the assistant UE 106 could transmit with the same duty cycle or scheduling restriction as the target UE 104. Transmission intervals of the assistant UE 106 would be scheduled during inactive periods of the target UE 104. The RAN 108 may buffer the transmission of the target UE 104 and aggregate the information of the two transmissions during a demodulation procedure.

In configuration 1012, the target UE 104 and assistant UE 106 may transmit at the same time and on the same frequency. The assistant UE 106 may deploy a diversity scheme such as, for example, cyclic-delay diversity (CDD). Such schemes may at least partially mitigate degradation at a receiver antenna.

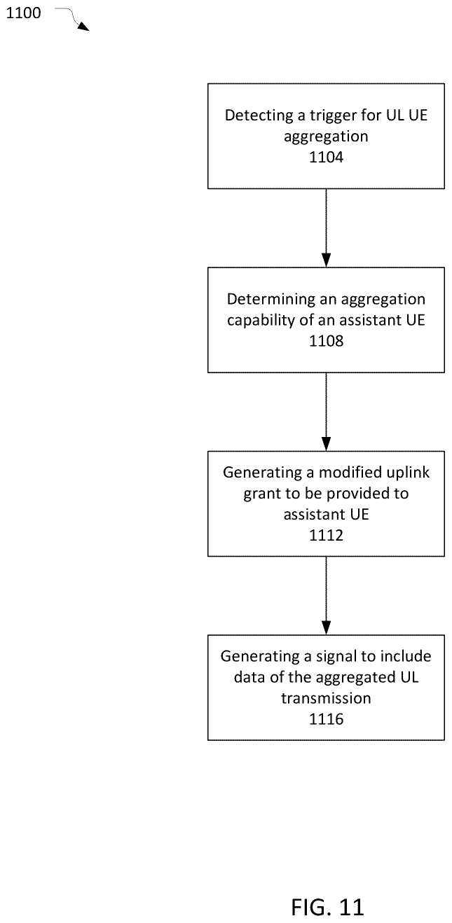

FIG. 11 illustrates an operational flow/algorithmic structure 1100 in accordance with some embodiments. The operation flow/algorithmic structure 1100 may be performed or implemented by a UE such as, for example, the target UE 104 or UE 1400; or components thereof, for example, baseband processor circuitry 1404A.

The operation flow/algorithmic structure 1100 may include, at 1104, detecting a trigger for UL UE aggregation. In some embodiments, the trigger may be detected by the target UE detecting that an uplink transmission rate is below a predetermined threshold or detecting that an uplink transmission rate is less than an uplink data arrival rate.

The operation flow/algorithmic structure 1100 may further include, at 1108, determining an aggregation capability of an assistant UE. In some embodiments, this determination may be based on a capability exchange and authentication procedure performed between the target UE and the assistant UE.

In some embodiments, the aggregation capability of the assistant UE may indicate the assistant UE is capable of communicating with an NTN. In some embodiments, the aggregation capability may indicate the assistant UE and the target UE both have a connection with a common radio access network node. In some embodiments, the aggregation capability may indicate the assistant UE has an uplink transmission load less than a predetermined threshold. In some embodiments, the aggregation capability may indicate the UE is within a predetermined threshold distance from the target UE.

In some embodiments, the target UE may provide a report to the base station that includes an identity of the assistant UE and an indication that the assistant UE is to assist with the aggregated uplink transmission.

The operation flow/algorithmic structure 1100 may further include, at 1112, generating a modified uplink grant to be provided to the assistant UE. In some embodiments, the modified uplink grant may allocate a portion of the uplink grant to the assistant UE. The portion may be a portion in a time domain or a frequency domain.

In some embodiments, the uplink grant may be determined based on a CG configuration. In these embodiments, the target UE may generate, and subsequently transmit, a signal to include an RNTI associated with the target UE.

In some embodiments, the uplink grant may be determined based on a DG configuration. In these embodiments, the target UE may generate, and subsequently transmit, a signal to include at least a portion of a PUSCH configuration received/processed at the target UE.

In some embodiments, the target UE may select a sidelink resource and provide data to the assistant UE on the selected sidelink resource. The data may be at least a part of the data to be transmitted in the aggregated UL transmission. In some embodiments, the sidelink resources may have a periodicity equal to a periodicity of a configured uplink. If the uplink grant is a dynamic uplink grant, the sidelink resource may be aperiodic.

In some embodiments, the sidelink resource may be selected based on a priority that is related to a priority of the uplink grant. For example, the sidelink priority, which is based on the uplink priority, may be determined based on a physical layer data priority mapping, a logical channel priority mapping, or a 5QI-to-PQI mapping.

In some embodiments, in selecting the sidelink resource, the target UE may select a number of subchannels based on a frequency allocation of the uplink grant.

In some embodiments, the sidelink resources may be selected from a resource selection window that is set based on the modified uplink grant. For example, the resource selection window may end an offset before a starting time of the modified uplink grant.

The operation flow/algorithmic structure 1100 may further include, at 1116, generating a signal to include data of the aggregated UL transmission. The signal may be generated to be transmitted on a portion of the uplink grant reserved for use by the target UE. In some embodiments, the signal may be a PUSCH transmission. In some embodiments, the target UE may transmit a MAC CE, associated with the PUSCH transmission, with an identifier associated with the target UE.

While the portion of the uplink grant allocated to the assistant UE may be different than the portion of the uplink grant reserved for the target UE, in other embodiments, the portions may be the same. For example, both the assistant UE and the target UE may jointly transmit uplink transmissions on the same time/frequency resources.

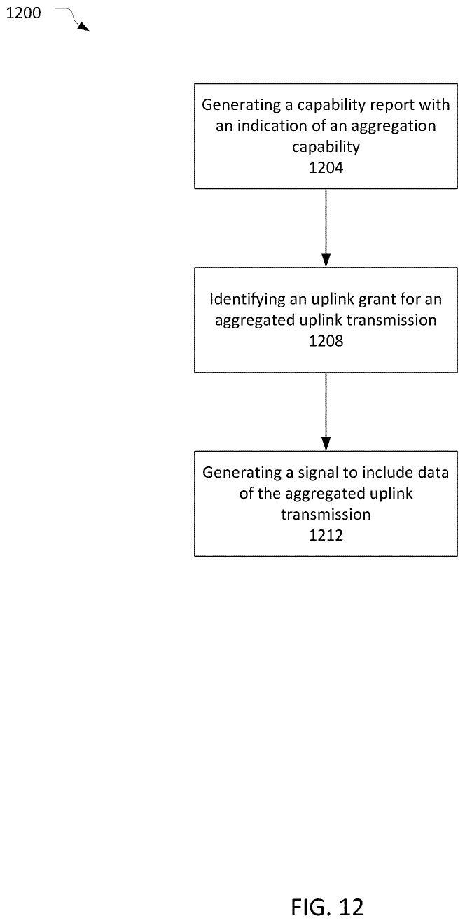

FIG. 12 illustrates an operational flow/algorithmic structure 1200 in accordance with some embodiments. The operation flow/algorithmic structure 1200 may be performed or implemented by a UE such as, for example, the assistant UE 106 or UE 1400; or components thereof, for example, baseband processor circuitry 1404A.

The operation flow/algorithmic structure 1200 may include, at 1204, generating a capability report. The capability report may include an indication of an aggregation capability of the assistant UE. The capability report may be transmitted to the target UE. This transmission may occur over a sidelink channel. In some embodiments, the capability report may be transmitted as part of a capability exchange and authentication of the assistant UE.

The operation flow/algorithmic structure 1200 may further include, at 1208, identifying an uplink grant for aggregated uplink transmission.

In some embodiments, the uplink grant may be received directly from a RAN node, for example, a base station. The uplink grant may be identified based on an RNTI received from the target UE. In some embodiments, upon receiving the uplink grant from the RAN node, the assistant UE may transmit a scheduling report to the target UE to provide an indication of the uplink grant.

In some embodiments, the uplink grant may be received from the target UE. The uplink grant may be a modified uplink grant that is derived from an overall uplink grant received by the target UE. In other embodiments, the uplink grant may be dedicated to the assistant UE but be provided to the assistant UE via the target UE.

The operation flow/algorithmic structure 1200 may further include, at 1212, generating a signal to include data of the aggregated uplink transmission. The signal may be transmitted to a RAN. In some embodiments, aggregated uplink transmission may be a PUSCH transmission, and the assistant UE may also transmit a MAC CE associated with the PUSCH transmission. The MAC CE may include a UE ID associated with the assistant UE. The RAN may use the UE ID to generate uplink control parameters (e.g., a TA command or uplink transmit power command) that are provided to the assistant UE.

In some embodiments, the signal may be generated based on a PMI configuration received from the target UE.

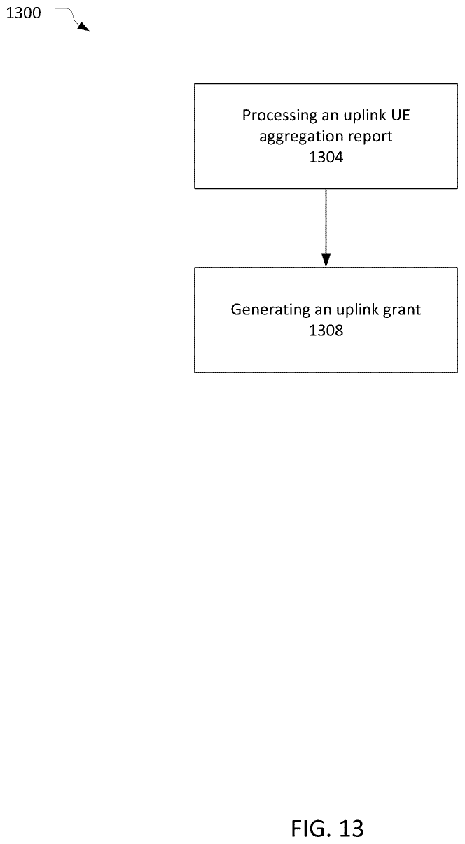

FIG. 13 illustrates an operational flow/algorithmic structure 1300 in accordance with some embodiments. The operation flow/algorithmic structure 1300 may be performed or implemented by a RAN node such as, for example, a node of the RAN 108 or network node 1500; or components thereof, for example, baseband processor 1504A.

The operation flow/algorithmic structure 1300 may include, at 1304, processing an uplink UE aggregation report. The uplink UE aggregation report may be received from a target UE and may include an identity of an assistant UE and an indication that the assistant UE is to cooperate with the target UE for uplink UE aggregation.

The operation flow/algorithmic structure 1200 may further include, at 1208, generating an uplink grant.

In some embodiments, the uplink grant may be for the target UE and may be transmitted to the target UE. This uplink grant may be considered an overall grant that the target UE uses to generate a modified UL grant that is then provided to the assistant UE.

In some embodiments, the uplink grant may include a first grant for the target UE and a second grant for the assistant UE. Both the first and second grants may be provided to the target UE. Alternatively, the first grant may be provided to the target UE and the second grant may be provided directly to the assistant UE.

In some embodiments, the first grant may be associated with a first ARFCN value and the second grant may be associated with a second ARFCN value that is different from the first ARFCN. This may separate the uplink transmissions from the target UE and the assistant UE in the frequency domain.

In other embodiments, both the first grant and the second grant may be associated with a common ARFCN value. In these embodiments, the grants may be separated in a time domain by being associated with first and second transmission intervals, respectively. Alternatively, the grants may correspond to the same time and frequency resources.

In some embodiments, the RAN node may determine the target UE is a source of a first uplink transmission of the aggregated uplink transmission and the assistant UE is a source of a second uplink transmission of the aggregated uplink transmission. Based on these determinations, the RAN node may generate first uplink control parameters for the target UE based on the first uplink transmission and second uplink control parameters for the assistant UE based on the second uplink transmission. The uplink control parameters may include an uplink power control parameter or a timing advance parameter that are then fed back to the appropriate UEs.

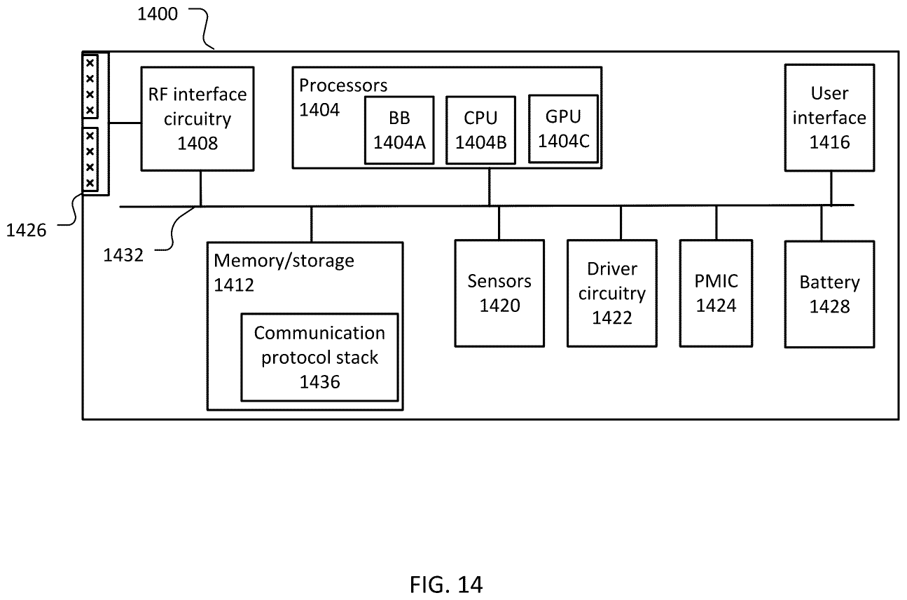

FIG. 14 illustrates an example UE 1400 in accordance with some embodiments. The UE 1400 may be any mobile or non-mobile computing device, such as, for example, a mobile phone, a computer, a tablet, an industrial wireless sensor (for example, a microphone, a carbon dioxide sensor, a pressure sensor, a humidity sensor, a thermometer, a motion sensor, an accelerometer, a laser scanner, a fluid level sensor, an inventory sensor, an electric voltage/current meter, or an actuators), a video surveillance/monitoring device (for example, a camera), a wearable device (for example, a smart watch), or an Internet-of-things (IoT) device.

The UE 1400 may include processors 1404, RF interface circuitry 1408, memory/storage 1412, user interface 1416, sensors 1420, driver circuitry 1422, power management integrated circuit (PMIC) 1424, antenna structure 1426, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangement of the components shown may occur in other implementations.

The components of the UE 1400 may be coupled with various other components over one or more interconnects 1432, which may represent any type of interface circuitry of a processor or a memory, input/output, bus (local, system, or expansion), transmission line, trace, optical connection, etc. that allows various circuit components (on common or different chips or chipsets) to interact with one another.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1400 to perform operations such as those described with respect to FIG. 7 or elsewhere herein.

In some embodiments, the baseband processor circuitry 1404A may access a communication protocol stack 1436 in the memory/storage 1412 to communicate over a 3GPP compatible network. In general, the baseband processor circuitry 1404A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1412 may include one or more non-transitory, computer-readable media that includes instructions (for example, communication protocol stack 1436) that may be executed by one or more of the processors 1404 to cause the UE 1400 to perform operations such as those described in operation flows/algorithmic structures 1100, 1200, or otherwise described herein.

The memory/storage 1412 include any type of volatile or non-volatile memory that may be distributed throughout the UE 1400. In some embodiments, some of the memory/storage 1412 may be located on the processors 1404 themselves (for example, L1 and L2 cache), while other memory/storage 1412 is external to the processors 1404 but accessible thereto via a memory interface. The memory/storage 1412 may include any suitable volatile or non-volatile memory such as, but not limited to, dynamic random-access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1408 may include transceiver circuitry and radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1426 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1426.

In various embodiments, the RF interface circuitry 1408 may be configured to transmit/receive signals in a manner compatible with NR or other access technologies.

The antenna structure 1426 may include antenna elements to convert electrical signals into radio waves to travel through the air and to convert received radio waves into electrical signals. The antenna elements may be arranged into one or more antenna panels. The antenna structure 1426 may have antenna panels that are omnidirectional, directional, or a combination thereof to enable beamforming and multiple-input, multiple-output communications. The antenna structure 1426 may include microstrip antennas, printed antennas fabricated on the surface of one or more printed circuit boards, patch antennas, phased array antennas, etc. The antenna structure 1426 may have one or more panels designed for specific frequency bands including bands in FR1 or FR2.

The user interface 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1400.

The sensors 1420 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various input/output (I/O) devices that may be present within, or connected to, the UE 1400. For example, driver circuitry 1422 may include a display driver to control and allow access to a display device, a touchscreen driver to control and allow access to a touchscreen interface, sensor drivers to obtain sensor readings of sensors 1420 and control and allow access to sensors 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

In some embodiments, the PMIC 1424 may control, or otherwise be part of, various power saving mechanisms of the UE 1400. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1400 may power down for brief intervals of time and thus save power. If there is no data traffic activity for an extended period of time, then the UE 1400 may transition off to an RRC_Idle state, where it disconnects from the network and does not perform operations such as channel quality feedback, handover, etc. The UE 1400 goes into a very low power state, and it performs paging where again it periodically wakes up to listen to the network and then powers down again. The UE 1400 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1428 may power the UE 1400, although in some examples the UE 1400 may be mounted deployed in a fixed location and may have a power supply coupled to an electrical grid. The battery 1428 may be a lithium-ion battery, a metal-air battery, such as a zinc-air battery, an aluminum-air battery, a lithium-air battery, and the like. In some implementations, such as in vehicle-based applications, the battery 1428 may be a typical lead-acid automotive battery.

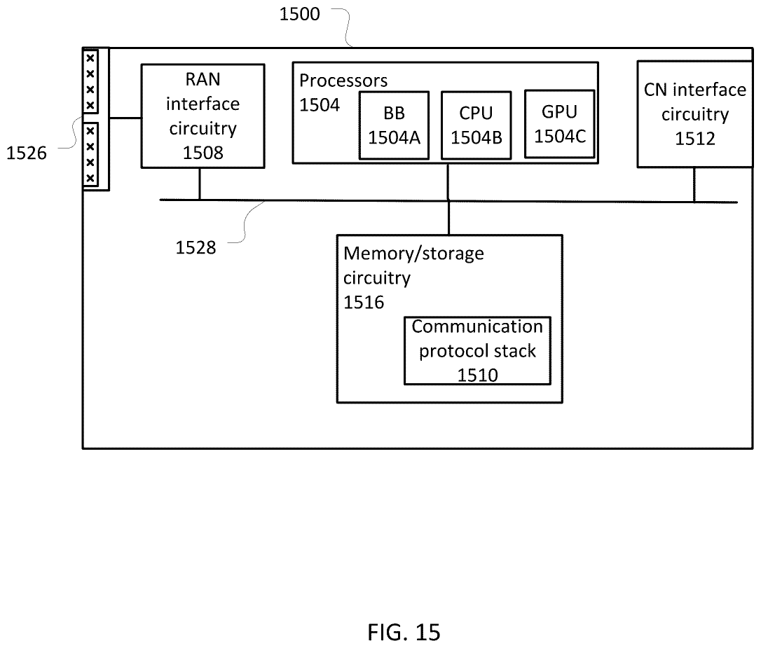

FIG. 15 illustrates an example network node 1500 in accordance with some embodiments. The network node 1500 may include processors 1504, RF interface circuitry 1508, core network (CN) interface circuitry 1512, memory/storage circuitry 1516, and antenna structure 1526.

The components of the network node 1500 may be coupled with various other components over one or more interconnects 1528.

The processors 1504, RF interface circuitry 1508, memory/storage circuitry 1516 (including communication protocol stack 1510), antenna structure 1526, and interconnects 1528 may be similar to like-named elements shown and described with respect to FIG. 14.

The processors 1504 may include any type of circuitry or processor circuitry that executes or otherwise operates computer-executable instructions, such as program code, software modules, or functional processes from memory/storage 1516 to cause the network node 1500 to perform operations such as those described in operation flow/algorithmic structure 1300 or otherwise described herein.

The CN interface circuitry 1512 may provide connectivity to a core network, for example, a 15^{th} Generation Core network (5GC) using a 15GC-compatible network interface protocol such as carrier Ethernet protocols, or some other suitable protocol. Network connectivity may be provided to/from the network node 1500 via a fiber optic or wireless backhaul. The CN interface circuitry 1512 may include one or more dedicated processors or FPGAs to communicate using one or more of the aforementioned protocols. In some implementations, the CN interface circuitry 1512 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method to be implemented by a component of a target UE, the method comprising: detecting a trigger for uplink UE aggregation; determining an aggregation capability of an assistant user equipment (UE); identifying an uplink grant for an aggregated uplink transmission; generating a modified uplink grant to be provided to the assistant UE based on the uplink grant; and generating a signal to include data of the aggregated uplink transmission.

Example 2 includes the method of example 1 is some other example herein, wherein detecting the trigger comprises: detecting that an uplink transmission rate is below a predetermined threshold; or detecting that an uplink transmission rate is less than an uplink data arrival rate.

Example 3 includes a method of example one some other example herein, wherein determining the aggregation capability of the assistant UE comprises: determining the assistant UE is capable of communicating with a non-terrestrial network; determining the assistant UE and the target UE both have a connection with a common radio access network node; determining the assistant UE has an uplink transmission load less than a predetermined threshold; or determining the assistant UE is within a predetermined threshold distance from the target UE.

Example 4 includes the method of example 1 or some other example herein, further comprising: generating a report to be transmitted to a base station, wherein the report includes an identity of the assistant UE and an indication that the assistant UE is to assist with the aggregated uplink transmission.

Example 5 includes a method of example 1 or some other example herein, wherein the modified uplink grant is to allocate a portion of the uplink grant, in a time domain or a frequency domain, to the assistant UE.

Example 6 includes a method of example 5 or some other example herein, further comprising: determining the uplink grant based on a configured grant (CG) configuration; and generating one or more signals to be provided to the assistant UE, the one or more signals to include the modified uplink grant and a radio network temporary identifier (RNTI) associated with the target UE.

Example 7 includes a method of example 5 or some other example herein, further comprising: determining the uplink grant based on a dynamic grant (DG) configuration; processing a physical uplink shared channel (PUSCH) configuration; and generating one or more signals to be provided to the assistant UE, the one or more signals to include the modified uplink grant and at least a portion of the PUSCH configuration.

Example 8 includes a method of example 1 or some other example herein, further comprising: selecting a sidelink resource; and generating a signal to transmit uplink data to the assistant UE via the sidelink resource, wherein the uplink grant is a configured uplink grant and the sidelink resource has a periodicity equal to a periodicity of the configured uplink grant, or the uplink grant is a dynamic uplink grant and the sidelink resource is aperiodic.

Example 9 includes the method of example 8 or some other example herein, further comprising: determining a first priority associated with the uplink grant; determining a second priority based on the first priority; and selecting the sidelink resource based on the second priority.

Example 10 includes a method of example 9 or some other example herein, further comprising: determining the second priority based on a physical layer data priority mapping, a logical channel priority mapping, or a 5G quality of service identifier (5QI) to PC5 5QI (PQI) mapping.

Example 11 includes the method of example 8 or some other example herein, further comprising: determining a frequency allocation of the uplink grant; and selecting a number of subchannels of the sidelink resource based on the frequency allocation.

Example 12 includes the method of example 1 or some other example herein, further comprising: selecting a sidelink resource from a resource selection window that ends an offset before a starting time of the modified uplink grant; and generating a signal to transmit uplink data to the assistant UE via the sidelink resource.

Example 13 includes the method of example 1 or some other example herein, wherein the signal is a physical uplink shared channel (PUSCH) transmission by the target UE to a base station and the method further comprises: generating a media access control (MAC) control element (CE) to include an identifier associated with the target UE, wherein the MAC CE is associated with the PUSCH transmission.

Example 14 includes a method to be implemented by a component of an assistant user equipment (UE), the method comprising: generating a capability report with an indication of an aggregation capability of the assistant UE, the capability report to be transmitted to a target UE; identifying an uplink grant for an aggregated uplink transmission; and generating a signal to include data of the aggregated uplink transmission.

Example 15 includes the method of example 14 or some other example herein, further comprising: determining, based on a message received from the target UE, a radio network temporary identifier (RNTI); and identifying the uplink grant based on the RNTI.

Example 16 includes the method of example 15 or some other example herein, further comprising: generating a scheduling report with an indication of the uplink grant, the scheduling report to be transmitted to the target UE.

Example 17 includes the method of example 14 or some other example herein, wherein the uplink grant is a modified uplink grant received from the target UE.

Example 18 includes the method of example 17 or some other example herein, further comprising: determining, based on a message received from the target UE, a precoding matrix indicator (PMI) configuration to be used for the signal.

Example 19 includes the method of example 14 or some other example herein, further comprising: determining, based on one or more messages from the target UE or a base station, a timing advance (TA) command and a transmit power control (TPC) command; and generating the signal based on the TA command and the TPC command.

Example 20 includes the method of example 19 or some other example herein, wherein the one or more messages include a downlink control information (DCI) format 2_2 with the TPC command.

Example 21 includes the method of example 19 or some other example herein, wherein the TA command is a group common TA command.

Example 22 includes the method of example 14 or some other example herein, further comprising: generating the signal with cyclic diversity delay.

Example 23 includes a method comprising: processing a report received from a target user equipment (UE), the report includes an identity of an assistant UE and an indication that the assistant UE is to cooperate with the target UE for uplink UE aggregation; and generating, based on the report, an uplink grant for an aggregated uplink transmission.

Example 24 includes the method of example 23 or some other example herein, wherein the uplink grant is for the target UE and is to be transmitted to the target UE.

Example 25 includes the method of example 23 or some other example herein, wherein the uplink grant includes a first grant for the target UE that is to be transmitted to the target UE and a second grant for the assistant UE.

Example 26 includes the method of example 25 or some other example herein, wherein the first grant is associated with a first absolute radio-frequency channel number (ARFCN) value and the second grant is associated with a second ARFCN value that is different from the first ARFCN value.

Example 27 includes the method of example 25 or some other example herein, wherein both the first grant and the second grant are associated with a first absolute radio-frequency channel number (ARFCN) value.

Example 28 includes the method of example 27 or some other example herein, wherein the first grant is associated with a first transmission interval and the second grant is associated with a second transmission interval that is different from the second transmission interval.

Example 29 includes the method of example 25 or some other example herein, wherein the second grant is to be transmitted to the target UE or the assistant UE.

Example 30 includes the method of example 23 or some other example herein, further comprising: determining the target UE is a source of a first uplink transmission of the aggregated uplink transmission; determining the assistant UE is a source of a second uplink transmission of the aggregated uplink transmission; generating first uplink control parameters for the target UE based on the first uplink transmission; and generating second uplink control parameters for the assistant UE based on the second uplink transmission.

Example 31 includes the method of example 30 or some other example herein, wherein the first uplink control parameters or the second uplink control parameters include an uplink power control parameter or a timing advance parameter.

Another example may include an apparatus comprising means to perform one or more elements of the method described in or related to any of examples 1-31, or any other method or process described herein.

Another example may include one or more non-transitory computer-readable media comprising instructions to cause an electronic device, upon execution of the instructions by one or more processors of the electronic device, to perform one or more elements of the method described in or related to any of examples 1-31, or any other method or process described herein.

Another example may include an apparatus comprising logic, modules, or circuitry to perform one or more elements of the method described in or related to any of examples 1-31, or any other method or process described herein.

Another example may include a method, technique, or process as described in or related to any of examples 1-31, or portions or parts thereof.

Another example may include an apparatus comprising: one or more processors and one or more computer-readable media comprising instructions that, when executed by the one or more processors, cause the one or more processors to perform the method as described in or related to any of examples 1-31, or any other method or process described herein.

Another example may include an apparatus comprising: processing circuitry to perform the method described in or related to any of examples 1-31, or any other method of process described herein; and interface circuitry, coupled with the processing circuitry, the interface circuitry to communicatively couple the processing circuitry to one or more components of a computing platform.

Another example may include a signal as described in or related to any of examples 1-31, or portions thereof.

Another example may include a datagram, information element, packet, frame, segment, PDU, or message as described in or related to any of examples 1-31, or portions thereof, or otherwise described in the present disclosure.

Another example may include a signal encoded with data as described in or related to any of examples 1-31, or portions or parts thereof, or otherwise described in the present disclosure.

Another example may include a signal encoded with a datagram, IE, packet, frame, segment, PDU, or message as described in or related to any of examples 1-31, or portions thereof, or otherwise described in the present disclosure.

Another example may include an electromagnetic signal carrying computer-readable instructions, wherein execution of the computer-readable instructions by one or more processors is to cause the one or more processors to perform the method as described in or related to any of examples 1-31, or any other method of process describe herein.

Another example may include a computer program comprising instructions, wherein execution of the program by a processing element is to cause the processing element to carry out the method described in or related to any of examples 1-31, or any other method of process describe herein.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
detecting a trigger for uplink user equipment (UE) aggregation;
determining an aggregation capability of an assistant user equipment (UE);
generating, based on the aggregation capability and an uplink grant for an aggregated uplink transmission, a modified uplink grant for transmission to the assistant UE; and
generating a signal to include data of the aggregated uplink transmission.

2. The method of claim 1, wherein detecting the trigger comprises:
detecting that an uplink transmission rate is less than a predetermined threshold; or
detecting that an uplink transmission rate is less than an uplink data arrival rate.

3. The method of claim 1, wherein determining the aggregation capability of the assistant UE comprises:
determining the assistant UE is capable of communicating with a non-terrestrial network;
determining the assistant UE and a target UE both have a connection with a common radio access network node;
determining the assistant UE has an uplink transmission load less than a predetermined threshold; or
determining the assistant UE is within a predetermined threshold distance from the target UE.

4. The method of claim 1, further comprising:
generating a report to be transmitted to a base station, wherein the report includes an identity of the assistant UE and an indication that the assistant UE is to assist with the aggregated uplink transmission.

5. The method of claim 1, wherein the modified uplink grant is to allocate a portion of the uplink grant, in a time domain or a frequency domain, to the assistant UE.

6. The method of claim 5, further comprising:
determining the uplink grant based on a configured grant (CG) configuration; and
generating one or more signals to be transmitted to the assistant UE, the one or more signals to include the modified uplink grant and a radio network temporary identifier (RNTI) associated with a target UE.

7. The method of claim 5, further comprising:
determining the uplink grant based on a dynamic grant (DG) configuration;
processing a physical uplink shared channel (PUSCH) configuration; and
generating one or more signals for transmission to the assistant UE, the one or more signals to include the modified uplink grant and at least a portion of the PUSCH configuration.

8. The method of claim 1, further comprising:
selecting a sidelink resource; and
generating a signal to transmit uplink data to the assistant UE via the sidelink resource,
wherein the uplink grant is a configured uplink grant and the sidelink resource has a periodicity equal to a periodicity of the configured uplink grant, or
the uplink grant is a dynamic uplink grant and the sidelink resource is aperiodic.

9. The method of claim 8, further comprising:
determining a first priority associated with the uplink grant;
determining a second priority based on the first priority and a physical layer data priority mapping, a logical channel priority mapping, or a 5G quality of service identifier (5QI) to PC5 5QI (PQI) mapping; and
selecting the sidelink resource based on the second priority.

10. The method of claim 8, further comprising:
determining a frequency allocation of the uplink grant; and
selecting a number of subchannels of the sidelink resource based on the frequency allocation.

11. A baseband processor comprising:
processing circuitry to:
generate a capability report with an indication of an aggregation capability of the assistant UE, the capability report to be transmitted to a target UE;
identify an uplink grant for an aggregated uplink transmission; and
generate a signal to include data of the aggregated uplink transmission; and
interface circuitry coupled with the processing circuitry, the interface circuitry to provide the signal to another component of a device.

12. The baseband processor of claim 11, wherein the processing circuitry is further to:
determine, based on a message received from the target UE, a radio network temporary identifier (RNTI); and
identify the uplink grant based on the RNTI.

13. The baseband processor of claim 12, wherein the processing circuitry is further to:
generate a scheduling report with an indication of the uplink grant, the scheduling report to be transmitted to the target UE.

14. The baseband processor of claim 11, wherein the uplink grant is a modified uplink grant received from the target UE.

15. The baseband processor of claim 14, wherein the processing circuitry is further to:
determine, based on one or more messages received from the target UE or a base station, a precoding matrix indicator (PMI) configuration, a timing advance (TA) command, or a transmit power control (TPC) command to be used for the signal; and
generate the signal based on the PMI configuration, the TA command, or the TPC command.

16. A method comprising:
processing a report received from a target user equipment (UE), wherein the report includes an identity of an assistant UE and an indication that the assistant UE is to cooperate with the target UE for uplink UE aggregation; and
generating, based on the report, an uplink grant for an aggregated uplink transmission.

17. The method of claim 16, wherein the uplink grant is for the target UE and is to be transmitted to the target UE.

18. The method of claim 16, wherein the uplink grant includes a first grant for the target UE that is to be transmitted to the target UE and a second grant for the assistant UE.

19. The method of claim 18, wherein the first grant is associated with a first absolute radio-frequency channel number (ARFCN) value and the second grant is associated with a second ARFCN value that is different from the first ARFCN value; or
wherein both the first grant and the second grant are associated with a same ARFCN value.

20. The method of claim 16, further comprising:
determining the target UE is a source of a first uplink transmission of the aggregated uplink transmission;
determining the assistant UE is a source of a second uplink transmission of the aggregated uplink transmission;
generating first uplink control parameters for the target UE based on the first uplink transmission; and
generating second uplink control parameters for the assistant UE based on the second uplink transmission.
